(19) United States
(12) Patent Application Publication
(10) Pub. No.: US 2002/0005958 A1
(43) Pub. Date: Jan. 17, 2002

(54) Non-contact thickness-measuring device

(76) Inventor: Kazuma Sekiya, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 09/897,388

(22) Filed: Jul. 3, 2001

(30) Foreign Application Priority Data
Jul. 13, 2000 (JP) 2000-212867

(51) Int. Cl. G01B 11/06

(52) U.S. Cl. 356/631

(57) ABSTRACT

Disclosed is a non-contact type of thickness-measuring device for determining the thickness of a workpiece to be machined. It comprises: a laser light projecting means for projecting a ray of laser light to the top surface of the workpiece at a predetermined angle of incidence relative to the top surface of the workpiece; an imaging means for capturing the first ray of laser light reflected from the top surface of the workpiece and the second ray of laser light passing through the workpiece and reflecting from the bottom surface of the workpiece; and an arithmetic means for determining the thickness of the workpiece from the distance between the first point at which the first ray of laser light falls on the imaging means and the second point at which the second ray of laser light falls on the imaging means.

### BACKGROUND OF THE INVENTION

1. Field of the Invention

The present invention relates to a thickness-measuring device for determining the thickness of a workpiece such as a semiconductor wafer.

2. Related Arts

Referring to FIG. 4, a grinding machine 50 is used in grinding a semiconductor wafer to a desired thickness. As shown in the drawing, a pair of rails 53 is laid on an upright wall 52, which stands upright on the base 51 of the grinding machine 50. A slider 54 is driven on the rails 53 by an associated stepping motor 55 to be raised or lowered, carrying a grinding unit 11. A chuck table 10 is placed on the base 51, and a workpiece to be ground is positively held by the chuck table 10.

The grinding unit 11 comprises a spindle housing 12, a spindle 13 rotatably supported by the spindle housing 12, a grinding wheel 16 fixed to the tip of the spindle 13 via an associated mount 14, and a grind stone 15 fixed to the grinding wheel 16. When the spindle 13 rotates, the grindstone 15 rotates accordingly.

When a semiconductor wafer W is ground, it is fixedly held by the chuck table 10 so that it may be put under the grinding unit 11. The spindle 13 is rotated, and the grinding unit 11 is lowered until the grind stone 15 rotating at a high speed has been pushed against the semiconductor wafer W, thereby grinding the surface of the semiconductor wafer W.

As seen from the drawing, a thickness-measuring device 61 uses two needle-like sensors 60a and 60b in determining the thickness of the semiconductor wafer W. The lower sensor 60a is put on the surface of the chuck table 10 whereas the upper sensor 60b is put on the surface of the semiconductor wafer W. The thickness of the semiconductor wafer W can be determined in terms of the difference between the lower and upper levels at which the lower and upper sensors 60a and 60b extend.

Such thickness-measuring device, however, has the defect of injuring semiconductor wafers W with its needle-like sensors, and hence there is a fear of lowering the qualities of semiconductor wafers when their thickness is measured.

### SUMMARY OF THE INVENTION

One object of the present invention is to provide a non-contact thickness-measuring device capable of determining the thickness of a workpiece in non-contact way, thus assuring that the workpiece is prevented from being injured.

To attain this object a non-contact thickness-measuring device for determining the thickness of a workpiece to be machined according to the present invention comprises: a laser light projecting means for projecting a ray of laser light to the top surface of the workpiece at a predetermined angle of incidence relative to the top surface of the workpiece; an imaging means for capturing the first ray of laser light reflected from the top surface of the workpiece and the second ray of laser light passing through the thickness of the workpiece and reflecting from the bottom surface of the workpiece; and an arithmetic means for determining the thickness of the workpiece from the distance between the first point at which the first ray of laser light falls on the imaging means and the second point at which the second ray of laser light falls on the imaging means.

The thickness of the workpiece “t” is given by the following equation:

t=(a/2 sin θ₁)·tan θhd 2

where “a” stands for the distance between the first point and the second point; “θ₁” stands for the predetermined angle of incidence; and “θ₂” stands for the angle of refraction at which the ray of laser light goes in the workpiece.

The laser projecting means may comprise an infrared laser; the imaging means may comprise an infrared-sensitive camera and the workpiece may be a semiconductor wafer.

According to such thickness-measuring device of the present invention constructed as above, thickness of a workpiece is determined by capturing the first ray of laser light reflected from the top surface of the workpiece and the second ray of laser light passing through the thickness of the workpiece and reflecting from the bottom surface of the workpiece, thus assuring that the workpiece is prevented from being injured.

Further, in a case where the workpiece is neither transparent nor translucent, advantageously thickness of the workpiece can be measured without being injured as same in a case where the workpiece is transparent or translucent by using the infrared laser, since the infrared rays can pass through even such workpiece.

Other objects and advantages of the present invention will be understood from the following description of a non-contact thickness-measuring device according to one preferred embodiment of the present invention, which is shown in accompanying drawings.

### BRIEF DESCRIPTION OF THE DRAWING

FIG. 1 is a perspective view of a grinding machine equipped with a non-contact thickness-measuring device according to the present invention;

FIG. 2 illustrates the principle according to which the thickness of a workpiece can be determined;

FIG. 3 illustrates the part of a cutting machine to which a non-contact thickness-measuring device according to the present invention is attached; and

FIG. 4 is a perspective view of a grinding machine equipped with a conventional thickness-measuring device.

### DETAILED DESCRIPTION OF PREFERRED EMBODIMENT

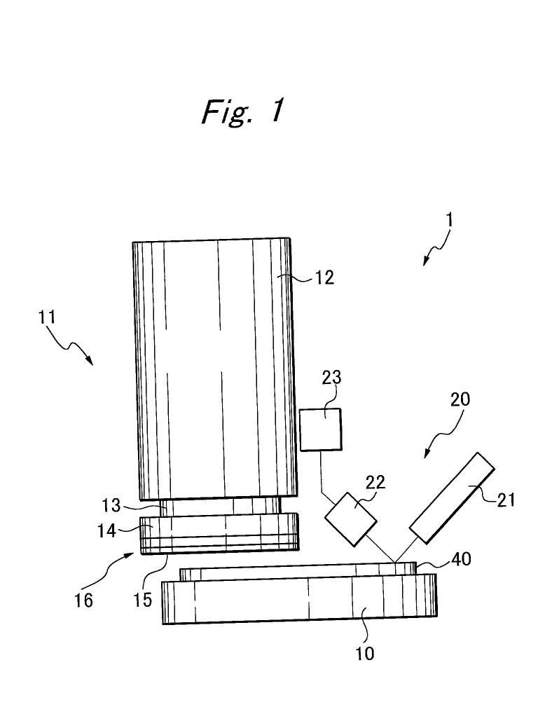

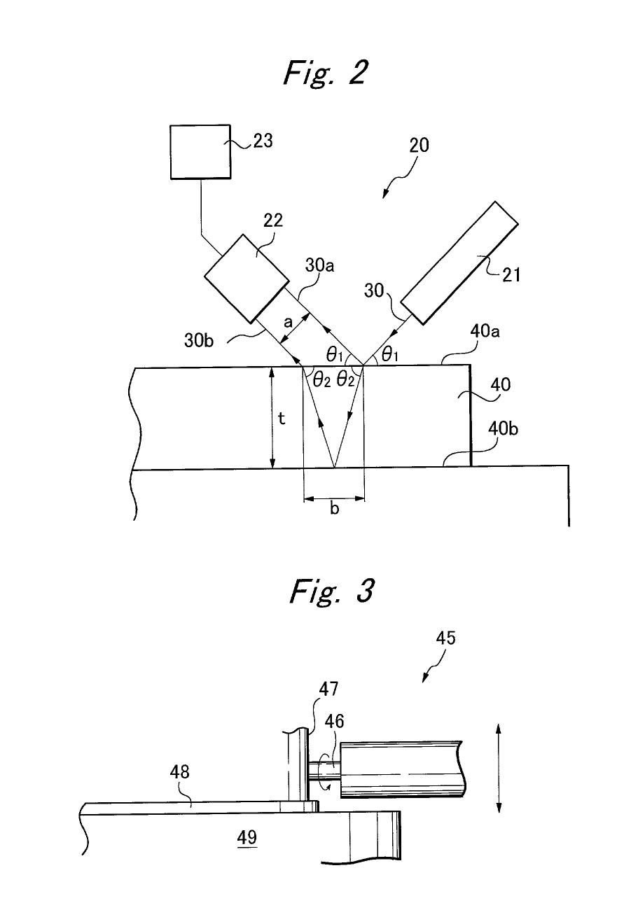

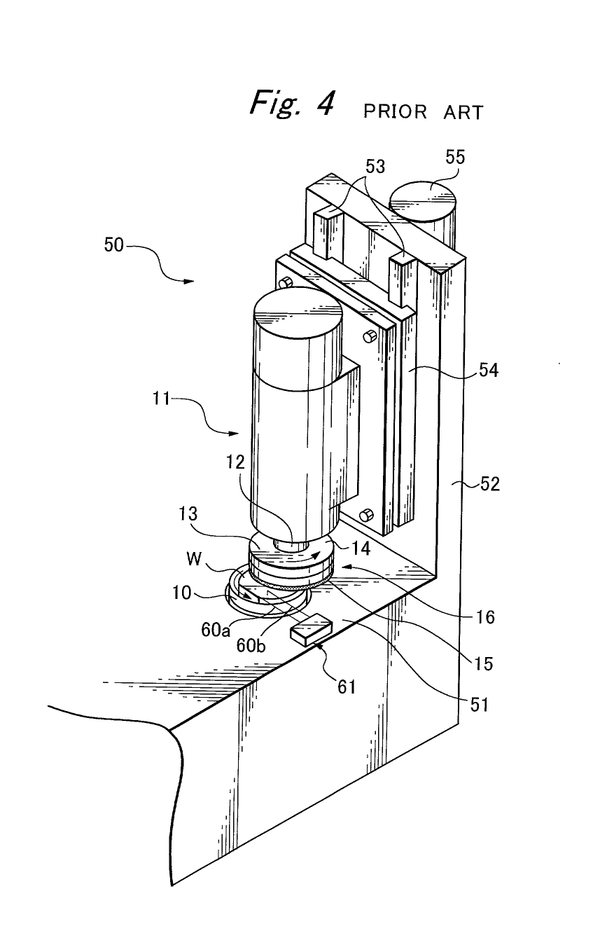

Referring to FIGS. 1 and 2, in which same parts as appear in FIG. 4 are indicated by same reference numerals, a workpiece 40 is fixedly held by the chuck table 10, and the grind stone 14 is fixed to the tip of the spindle 13 via the mount 14, and the spindle 13 is rotatably supported by the spindle housing 12.

A laser light projecting means 21 is so placed in the vicinity of the workpiece 40 that the ray of laser light may be thrown to the workpiece 40 obliquely, and a imaging means 22 is so placed that the ray of laser light may fall on the imaging means 22 after being reflected on the top surface of the workpiece 40. The imaging means 22 is connected to an arithmetic means 23 for determining the thickness of the workpiece from the distance “a” between the first point at which the first ray of laser light 30a falls on the imaging means 22 and the second point at which the second ray of laser light 30b falls on the imaging means 22.

In FIG. 2, the ray of laser light projecting means 21 throws a ray of laser light 30 to the top surface 40a of the workpiece 40 at a predetermined angle of incidence θ₁, which is smaller than 90 degrees.

A division of ray of laser light is reflected from the top surface 40a of the workpiece 40, and the remaining division of ray of laser light is refracted at the top surface 40a of the workpiece 40 to go in the workpiece 40, and then, the refracted ray of laser light is reflected from the bottom surface 40b of the workpiece 40, traveling to the top surface 40a of the workpiece 40, where the refracted ray of laser light is refracted again. Finally the refracted ray of laser light falls on the imaging means 22 as the second ray of laser light 30b.

As seen from FIG. 2, the first division of the ray of laser light 30 from the ray of laser light projecting means 21 is reflected on the top surface 40a of the workpiece 40 at the same angle θ₁ as the angle of incidence θ₁. The remaining second division of-the ray of laser light 30 is refracted on the top surface 40a of the workpiece 40 at an angle of refraction θ₂ to go in the thickness of the workpiece 40, and then, the second division of ray of laser light 30b is reflected on the bottom surface of the workpiece 40 to go to the top surface 40a of the workpiece 40, where the second division of ray of laser light 30b comes out at the same angle as the angle of incidence θ₁. Thus, the second ray of laser light 30b travels in parallelism with the first ray of laser light 30a, leaving the distance “a” therebetween. Finally these rays of laser light fall in the imaging means 22. The second division of ray of laser light comes out from the top surface of the workpiece 40 at the distance “b” apart from the point at which it goes in the workpiece. The distance “b” can be given by the following equation:

b=a/sin θ₁ (1)

The thickness “t” of the workpiece 40 is given by the following equation:

t=b·tan θ₂/2 (2)

By substituting Equation (1) for “b” in Equation (2) the following equation results:

t=(a/2 sin θ₁)·tan θ₂ (3)

In case a CCD camera is used as the imaging means which is composed of, for instance, 256 times 256 pixels, the distance “a” can be measured in terms of the number of pixels existing between the first point which the first ray of laser light 30a falls on and the second point which the second ray of laser light 30b falls on the camera's exposure plane.

As above mentioned, thickness of a workpiece can be determined by computation with capturing the first ray of laser light 30a and the second ray of laser light 30b without contact to the workpiece. Accordingly, the workpiece can be prevented from injuring, thus preventing from lowering the quality.

In a case where a workpiece is transparent or semi-opaque or translucent, the infrared laser need not be used, but in a case where a workpiece such as a silicon semiconductor wafer is neither transparent nor translucent, advantageously the infrared laser can be used. The infrared rays can pass through the semiconductor wafer, and then an infrared camera can be used as the imaging means 22.

The thickness-measuring device can be installed in a machining apparatus other than the grinding machine. Referring to FIG. 3, a cutting machine 45 has a cutting blade 47 attached to its spindle 46. The cutting blade 47 is lowered while rotating at a high speed, thus notching a workpiece 48 which is held by the chuck table 49. The thickness of the workpiece 48 must be watched constantly to assure that a “V”-shaped cut reaches short of the bottom of the workpiece 48.

What is claimed is:

1. A thickness-measuring device for determining thickness of a workpiece to be machined comprising:
a laser light projecting means for projecting a ray of laser light to a top surface of the workpiece at a predetermined angle of incidence relative to the top surface of the workpiece;
an imaging means for capturing the first ray of laser light reflected from the top surface of the workpiece and the second ray of laser light passing through the workpiece and reflecting from the bottom surface of the workpiece; and
an arithmetic means for determining the thickness of the workpiece from the distance between the first point at which the first ray of laser light falls on the imaging means and the second point at which the second ray of laser light falls on the imaging means.

2. A thickness-measuring device according to claim 1, wherein the thickness of the workpiece “t” is given by the following equation:
t=(a/2 sin θ₁)·tan θ₂
where “a” stands for the distance between the first point and the second point; “θ₁” stands for the predetermined angle of incidence; and “θ₂” stands for the angle of refraction at which the ray of laser light goes in the workpiece.

3. A thickness-measuring device according to claim 1 or 2, wherein the laser projecting means comprises an infrared laser; the imaging means comprises an infrared-sensitive camera and the workpiece is a semiconductor wafer.
